(19) United States
(12) Patent Application Publication
(10) Pub. No.: US 2012/0068880 A1
(43) Pub. Date: Mar. 22, 2012

(54) System and Method for Dual-Band Antenna Pointing, Acquisition, And Tracking

(75) Inventors: Johan A. Kullstam, Marlborough, MA (US); Terry A. Dorschner, Marlborough, MA (US)

(73) Assignee: RAYTHEON COMPANY, Waltham, MA (US)

(21) Appl. No.: 12/884,284

(22) Filed: Sep. 17, 2010

(51) Int. Cl. G01S 13/66; G01S 13/00

(52) U.S. Cl. 342/54; 342/81

(57) ABSTRACT

A system for tracking a target includes a dual-band antenna. The dual-band antenna includes a first antenna and a second antenna rigidly coupled to the first antenna. The first antenna is configured to communicate within a first frequency band and the second antenna is configured to communicate within a second frequency band. The system further includes a processing system having a first antenna control processor configured to initialize a pointing direction to point a beam of the first antenna toward the target with a first degree of pointing accuracy, and configured to scan with the first antenna to point the beam of the first antenna more precisely toward the target with a second degree of pointing accuracy, and further having a second antenna control processor configured to electronically scan with the second antenna to point a beam of the second antenna to the target with a third degree of pointing accuracy.

### FIELD OF THE INVENTION

The systems and methods described herein relate generally to systems and methods for acquiring and tracking a target and, more particularly to systems and methods for acquiring and tracking an airborne target with a dual-band antenna.

### BACKGROUND OF THE INVENTION

As is known in the art, some airborne and ground-based communication systems and networks can utilize radio frequency (RF) links or paths, which can be used for a variety of purposes, including, but not limited to, digital voice communications, analog voice communications, and data communications. As is also known, such RF systems include an RF antenna, which, in conjunction with a processing system, can point toward, acquire, and track a target, for example, an aircraft or a satellite. Thus, the RF system can establish and maintain an RF communications link, even in the presence of movement of the RF system or of the target.

As is also known, some other airborne and ground-based communication systems and networks can utilize free space optical (FSO) links or paths, which can be used for a variety of purposes, including, but not limited to, digital voice communications, analog voice communications, and data communications. As is also known, such FSO systems include an optical antenna, which, in conjunction with a processing system, can point toward, acquire, and track a target, for example, an aircraft or a satellite. Thus, the optical system can also and independently establish and maintain an optical communications link, even in the presence of movement of the FSO system or of the target.

Higher bandwidth (data rate) communication links tend to have lower reliability than lower bandwidth communication links. Thus, to maintain a communication link, some systems attempt to adjust a data rate in order to maintain link reliability and associated data quality.

In order to achieve pointing, acquisition, and tracking of a target with an RF link, some RF systems use one, two, or three axis gimbal arrangements upon which an RF antenna is mounted. The RF system can use one or a variety of scanning techniques to first acquire a target, for example, helical, raster, or nodding scans. Thereafter, the RF systems can track the target, i.e., keep pointed toward a moving target, using any number of known techniques.

Similarly, in order to achieve pointing, acquisition, and tracking of a target with an optical link, some optical systems use one, two, or three axis gimbal arrangements upon which an optical antenna is mounted. The optical system can also use one or a variety of scanning techniques to first acquire a target, for example, helical, raster, or nodding scans. Thereafter, the optical systems can track the target, i.e., keep pointed toward a moving target, using any number of known techniques.

As is known, acquisition and tracking of a target with an optical communications link is difficult to achieve, since a beamwidth of the optical antenna is quite small, typically in the range of 10 to 100 micro-radians, and therefore difficult to properly aim, particular if the target is moving or if a platform on which the optical antenna is mounted (e.g., an aircraft) is moving.

U.S. Pat. No. 6,816,112 describes a hybrid RF/optical pointing, acquisition, and tracking (PAT) system and method. This system uses separate optical and RF antennas, each on their own gimbal assembly and each of which independently acquires and tracks a target.

### SUMMARY OF THE INVENTION

The above and other problems are solved by having first and second antennas rigidly coupled together to form a dual-band antenna. The first antenna of the dual-band antenna is directionally steerable either electronically or via a gimbal assembly. The second antenna is electronically steerable. The first antenna has a relatively wide beamwidth and operates at a relative low frequency and the second antenna has a relatively narrow beamwidth and operates at a relatively high frequency. The two antennas are utilized in a cooperative fashion to facilitate pointing, acquisition, and tracking of a target.

In accordance with a first aspect of the present invention, a method of tracking a target includes initializing a pointing direction to point a beam of a first antenna toward the target with a first degree of pointing accuracy, wherein the first antenna is within a dual-band antenna, wherein the dual-band antenna includes the first antenna and a second antenna rigidly coupled to the first antenna. The first antenna is configured to communicate within a first frequency band and the second antenna is configured to communicate within a second frequency band higher in frequency than the first frequency band. The second antenna has an aperture width substantially smaller than an aperture width of the first antenna. The method also includes scanning with the first antenna to point a beam of the first antenna to the target with a second degree of pointing accuracy. The method also includes electronically scanning with the second antenna in directions related to the pointing direction of the beam of the first antenna to point a beam of the second antenna to the target with a third degree of pointing accuracy. The third degree of pointing accuracy is more accurate than the second degree of pointing accuracy, and the second degree of pointing accuracy is more accurate than the first degree of pointing accuracy.

In accordance with a second aspect of the present invention, a system for tracking a target includes a dual-band antenna. The dual-band antenna includes a first antenna and a second antenna rigidly coupled to the first antenna. The first antenna is configured to communicate within a first frequency band and the second antenna is configured to communicate within a second frequency band higher in frequency than the first frequency band. The second antenna has an aperture width substantially smaller than an aperture width of the first antenna. The system further includes a processing system. The processing system includes a first antenna control processor configured to initialize a pointing direction to point a beam of the first antenna toward the target with a first degree of pointing accuracy, and configured to scan with the first antenna to point the beam of the first antenna more precisely toward the target with a second degree of pointing accuracy. The processing system also includes a second antenna control processor configured to electronically scan with the second antenna in directions related to the pointing direction of the beam of the first antenna to point a beam of the second antenna to the target with a third degree of pointing accuracy. The third degree of pointing accuracy is more accurate than the second degree of pointing accuracy, and the second degree of pointing accuracy is more accurate than the first degree of pointing accuracy.

### BRIEF DESCRIPTION OF THE DRAWINGS

The foregoing features of the invention, as well as the invention itself may be more fully understood from the following detailed description of the drawings, in which:

FIG. 1 is a block diagram showing a space core network, an air network, a terrestrial core network, and an access network, all in communication;

FIG. 2 is a block diagram showing an exemplary dual-band antenna system having a processing system;

FIG. 2A is a block diagram showing another exemplary dual-band antenna system having a processing system;

FIG. 3 is a block diagram showing another exemplary dual-band antenna system having a processing system;

FIG. 4 is a block diagram showing further details of the processing systems of FIGS. 2 and 3;

FIG. 4A is a block diagram showing further details of the processing system of FIG. 2A;

FIG. 5 is a block diagram showing an initial alignment toward a target of first and second respective beams of first and second antennas of the dual-band antenna system of FIG. 2, 2A, or 3, which has a first degree of beam pointing accuracy;

FIG. 5A is a block diagram showing a modified alignment toward the target of the first and second respective beams of the first and second antennas of the dual-band antenna system of FIG. 2, 2A, or 3, which has a second degree of beam pointing accuracy;

FIG. 5B is a block diagram showing another modified alignment toward the target of the first and second respective beams of the first and second antennas of the dual-band antenna system of FIG. 2, 2A, or 3, which has a third degree of beam pointing accuracy;

FIG. 5C is a block diagram showing yet another modified alignment toward the target of the first and second beams of the first and second antennas of the dual-band antenna system of FIG. 2, 2A, or 3; and

FIG. 6 is a flow chart showing a process of alignment that can be used to align the first and second beams of the dual-band antenna systems of FIG. 2, 2A, or 3 in accordance with FIGS. 5-5C.

### DETAILED DESCRIPTION OF THE INVENTION

Before describing the present invention, some introductory concepts and terminology are explained. A used herein, the term “communication,” or “communication link,” is used herein to describe any form of exchange of information, including, but not limited to, data or voice from one point to another point.

As used herein, the term “free space optical” or “FSO” is used to describe an optical communication link through the air, through space, or through any non-wired medium including any liquid or any gas. It will be appreciated that the FSO link communicates using light at light wavelengths and light frequencies. It will also be appreciated that light can include both visible and invisible light.

As used herein, the term “radio frequency” or “RF” is used to describe a radio communication link that travels through the air, through space, or through any non-wired medium including any liquid or any gas. It will be appreciated that the RF link communicates using RF electromagnetic energy at RF wavelengths and RF frequencies.

As used herein, the term “RF frequency band” is used to describe a band of frequencies, continuous or discontinuous, within the RF frequency range. Many communication systems use RF frequency bands substantially smaller than the entire RF frequency range, which spans from about 300 Hz to about 3000 GHz.

Similarly, as used herein, the term “optical frequency band” is used to describe a band of frequencies, continuous or discontinuous, within the optical frequency range. Many communication systems use optical frequency bands substantially smaller than the entire optical frequency range of light, which is most often expressed in terms of wavelength and spans generally from about 10⁻⁷ to about 10⁻⁴ meters.

A used herein, the term “beamwidth” is used to describe a width characteristic of an energy beampattern transmitted by or received by an RF or optical antenna. Conventionally, the beamwidth is described as a planar or solid angle that intersects half power points (i.e., −3 dB) of the beam.

As used herein, the term “rigidly coupled,” for example, as pertains to two antennas that a rigidly coupled together, is used to refer to a rigid mechanical coupling of two antennas. However, the two antennas and/or the rigid coupling therebetween may be subject to mechanical and/or thermal stresses that cause the two antennas to move relative to each other as temperature changes or as the two antennas are mechanically moved. Beams of some of the antenna described herein can have beamwidths that are very narrow in angle, and thus, even though rigidly coupled, it is possible that beams generated by one (or both) of the antennas can move due to the mechanical or thermal stresses by an amount that is substantial compared to the beamwidths.

As used herein, the terms “pointing error” and “degree of pointing accuracy” are used to describe an error and an accuracy with which a beam of an antenna points toward a target, for example, a satellite. It will be understood that pointing error and degree of pointing accuracy have an inverse relationship. In other words, a large pointing error results in or from a small degree of pointing accuracy (less accurate), and a small pointing error results in or from a large degree of pointing accuracy (more accurate).

It will be understood that RF communication links suffer only minor degradation when in the presence of bad weather, for example, clouds. However, optical communication links can suffer substantial degradation or link loss in the presence of bad weather.

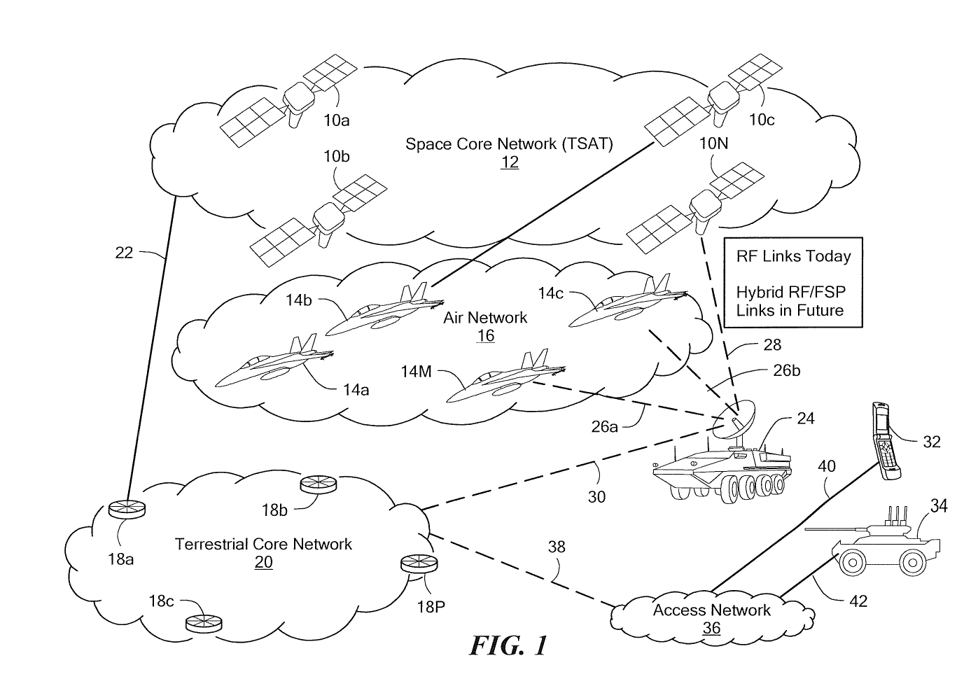

Referring now to FIG. 1, a plurality of satellites 10a-10N can communicate in a space core network 12 via RF links and/or via FSO links. The space core network 12 can include one or more of a variety of satellite networks, for example, a transformational satellite communications system (TSAT) network. However, other satellites or other satellite communication networks are possible.

A plurality of aircraft 14a-14M can communicate in an air network 16 via RF and/or via FSO links. One or more of the aircraft 14a-14M in the air network 16 can also communicate with one or more of the satellites 10a-10N in the space core network 12 via links 17, which can be RF links or FSO links, or both RF links and FSO links.

A plurality of systems, also referred to herein as “terminals” 18a-18P can communicate in a terrestrial core network 20 via RF and/or via FSO links. The terminals 18a-18P in the terrestrial core network 20 can also communicate with one or more of the satellites 10a-10N in the space core network 12 via one or more links 22, which can be RF links, FSO links, or both RF links and FSO links.

As is known, FSO links can carry much higher bandwidth and resulting data rates than RF links. FSO links typically operate in transmission rates between about one Gbit/sec and one hundred Gbit/sec.

A mobile platform 24, which can be a commercial or military mobile platform, can communicate with one or more of the aircraft 14a-14M in the air network 16 via links 26a, 26b, which can be RF links, FSO links, or both RF links and FSO links. The mobile platform 24 can also communicate with the one or more satellites in the space core network 12 via links 28, which can be RF links, FSO links, or both RF links and FSO links. The mobile platform 24 can also communicate with the one or more of the terminals 18a-18P in the terrestrial core network 20 via links 30, which can be wire links, RF links, FSO links, or any combination of wire links, RF links, and FSO links.

Other types of access networks, for example a wireless access network 36, can receive communications from communication platforms 32, 34 over wireless links 40, 42, which can be RF links, FSO links, or both RF links and FSO links. In turn, the access network 36 can communicate with one or more of the terminals 18a-18P in the terrestrial core network 20 via links 38, which can be fiber optic cable links, wire links, RF links, FSO links, or any combination of fiber optic cable links, wire links, RF links, and FSO links.

While both RF and optical links are described above for each communication link above, present fielded technology provides the links 17, 22, 26a, 26b, and 28 as RF links only, links within the space core network 12 as RF and/or optical, and the link 38 as wired, fiber optic, or RF.

Clouds shown as the space core network 12, the air network 16, and the terrestrial core network 20 are representative of communication interconnectivity described above.

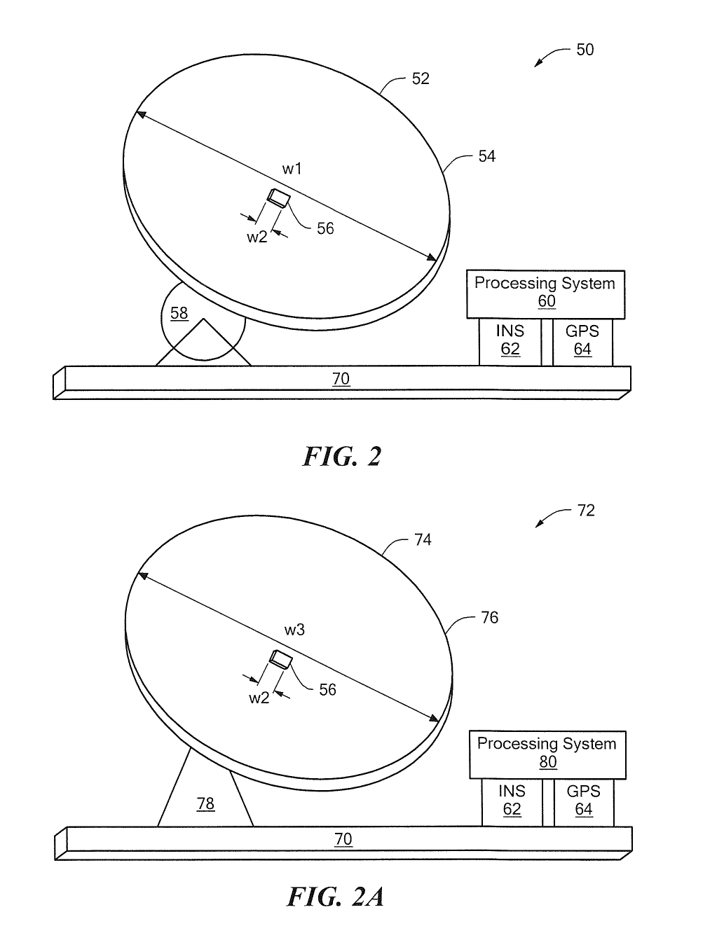

Referring now to FIG. 2, a system 50 for tracking a target includes a dual-band antenna 52. The dual-band antenna 52 includes a first antenna 54 and a second antenna 56 rigidly coupled to the first antenna 54. The first antenna 54 is configured to communicate within a first frequency band and the second antenna 56 is configured to communicate within a second frequency band higher in frequency than the first frequency band. The second antenna 56 has an aperture width, w2, substantially smaller than an aperture width, w1, of the first antenna. The system further includes a processing system 60 configured to control pointing directions of beams from the first and second antennas 54, 56, respectively.

As used above, the term “substantially” is used to mean at least three hundred percent.

The system 50 can include a gimbal assembly 58 coupled to rotationally move the dual-band antenna 52 about at least one axis in response to a gimbal control signal. The processing system 60 can be coupled to receive a signal from at least one of an inertial navigation system (INS) 62 or a global positioning system (GPS) 64. The processing system 60 can be configured to control a pointing direction of the dual-band antenna 52, and therefore, a beam of the first antenna 54, and to some degree, a beam of the second antenna 56 in ways described more fully below. The system 50 can be coupled to a frame 70, which can be a stationary frame or a moving frame. In some embodiments, the frame 70 is representative of an aircraft frame.

The inertial navigation system 62 is configured to provide an inertial navigation signal indicative of a position of the system 50, and the global positioning system 64 is configured to provide a global positioning signal indicative of earth-referenced coordinates of a location of the system 50.

In some embodiments, the first frequency band in which the first antenna 54 is configured to communicate is in the radio frequency range and the second frequency band in which the second antenna 56 is configured to communicate is in the light frequency range.

In some embodiments, the second antenna 56 comprises an optical phased array (OPA). The optical phased array 56 can be of a type, for example, described in U.S. Pat. No. 5,018,835, issued May 28, 1991, U.S. Pat. No. 5,093,740 issued May 3, 1992, or U.S. Pat. No. 7,215,472 issued May 8, 2007, each of which are assigned to the assignee of the present invention. However, other optical phased arrays are possible.

In other embodiments, both the first and second antennas 54, 56 are both configured to operate in the RF frequency range, but in substantially different RF frequency bands.

Referring now to FIG. 2A, a system 72 for tracking a target includes a dual-band antenna 74. The dual-band antenna 74 includes a first antenna 76 and the second antenna 56 rigidly coupled to the first antenna 76. The first antenna 76 is configured to communicate within a first frequency band and the second antenna 56 is configured to communicate within a second frequency band higher in frequency than the first frequency band. The second antenna 56 has an aperture width, w2, substantially smaller than an aperture width, w4, of the first antenna.

The system further includes a processing system 80 configured to control pointing directions of beams from the first and second antennas 76, 56, respectively. However, unlike control by way of the gimbal assembly 58 of FIG. 2, here the dual beam antenna 74 is rigidly attached to the frame 70 with a mount 78. In such and arrangement, the first antenna 76 is configured have electronically steered beams. Therefore, both the first antenna 76 and the second antenna 56 have electronically steered beams, e.g., both the first antenna 76 and the second antenna 56 are phased array antennas.

The first antenna 74, for example, can be comprised of a variable inclination continuous transverse stub (VICTS) antenna as made by the Raytheon Company. However, other electronically steered RF antennas are also possible, such as the active electronically scanned array (AESA), also made by Raytheon Company.

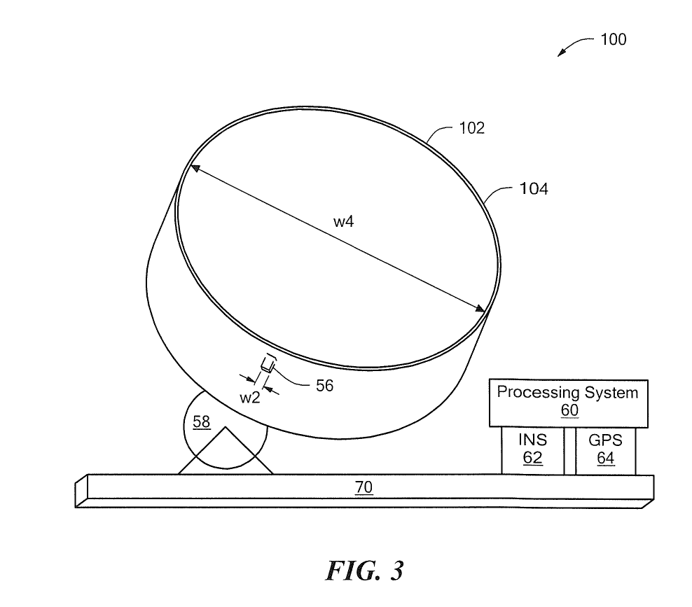

Referring now to FIG. 3, in which like elements of FIG. 2 are shown having like reference designations, a system 100 for tracking a target (not shown) is like the system 50 of FIG. 2, except a dual-band antenna 102 includes first antenna 104, in the form of a dish antenna, in place of the first antenna 54 of FIG. 2. The dual-band antenna 102 includes the first antenna 104 and the second antenna 56 rigidly coupled to the first antenna 104. The first antenna 104 is configured to communicate within a first frequency band and the second antenna 56 is configured to communicate within a second frequency band higher in frequency than the first frequency band. The second antenna 56 has an aperture width, w2, substantially smaller than an aperture width, w4, of the first antenna 104.

In some embodiments, the first frequency band in which the first antenna 104 is configured to communicate is in the radio frequency range and the second frequency band in which the second antenna 56 is configured to communicate is in the light frequency range.

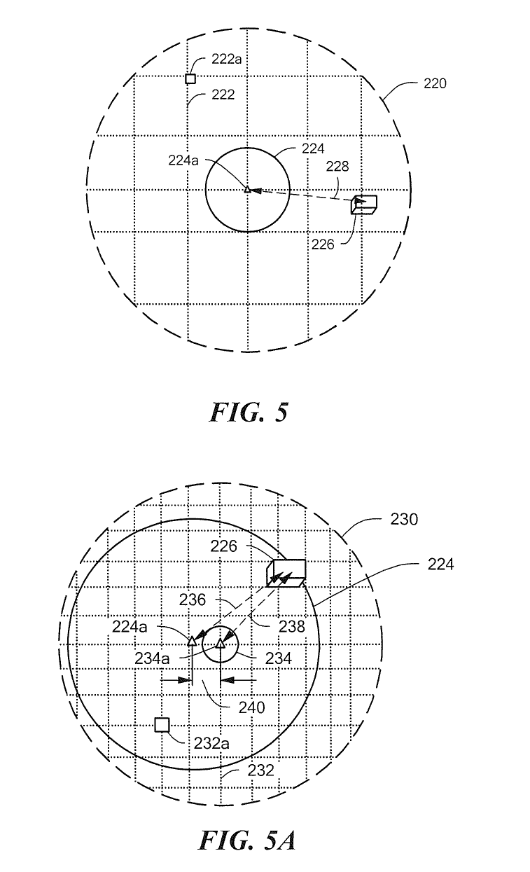

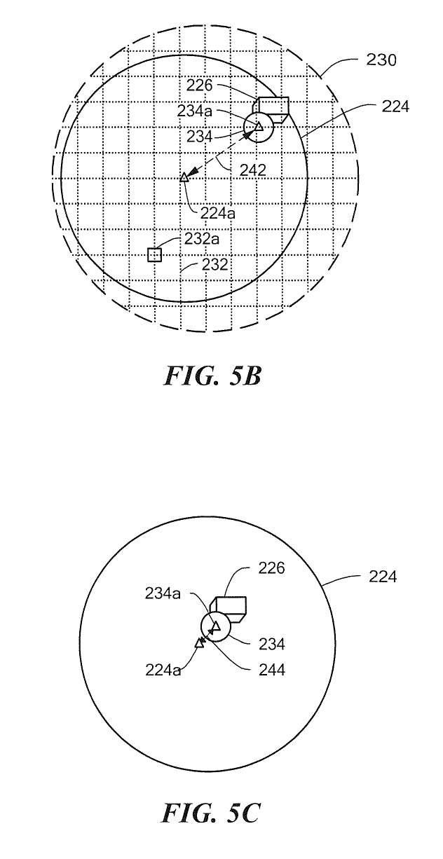

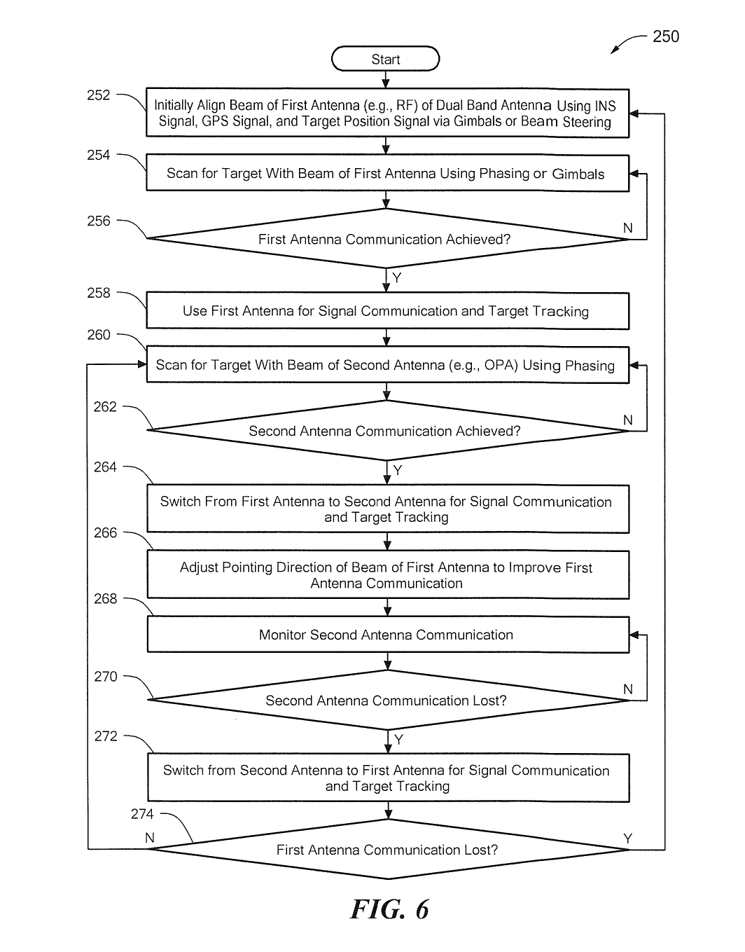

Operation of the systems 50, 72, and 100 of FIGS. 2, 2A, and 3, respectively, is first described below in conjunction with FIGS. 5, 5A, 5B, and 5C in a pictorial form, and then again, in conjunction FIG. 6 in a flow chart form.

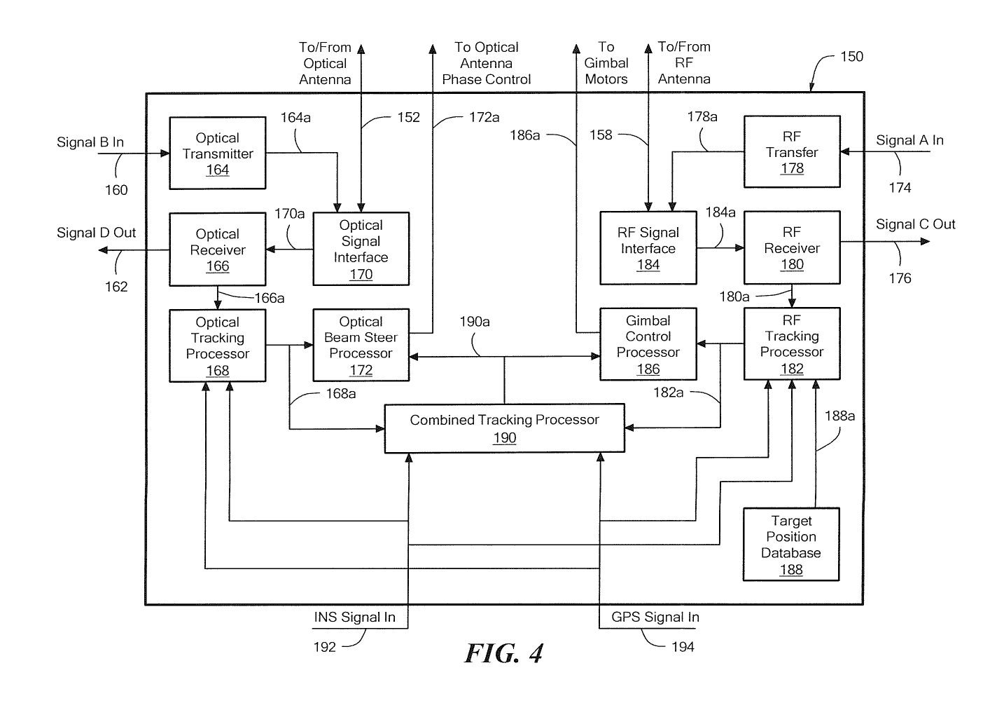

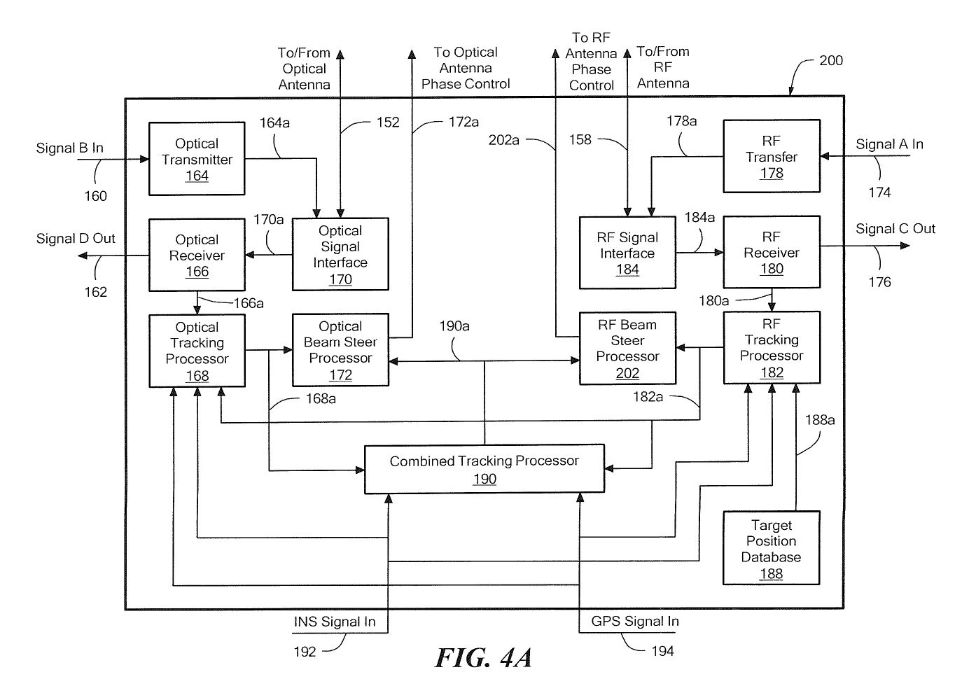

Referring now to FIG. 4, a processing system 150, which can be the same as or similar to the processing system 60 of FIGS. 2 and 3, includes a first antenna control processor 186, here in the form of a gimbal control processor 186, configured to initialize a pointing direction to point a beam of a first antenna (e.g., 54 or 104 of FIG. 2 or 3, respectively) toward a target with a first degree of pointing accuracy, and configured to scan with the first antenna (e.g., 54 or 104) to point the beam of the first antenna (e.g., 54 or 104) more precisely toward the target with a second degree of pointing accuracy. The processing system 150 also includes a second antenna control processor 172, here in the form of an optical beam steer processor 172, configured to electronically scan with the second antenna 56 of FIG. 2 or 3 to point a beam of the second antenna 56 to the target with a third degree of pointing accuracy. The third degree of pointing accuracy is more accurate than the second degree of pointing accuracy, and the second degree of pointing accuracy is more accurate than the first degree of pointing accuracy.

The system 72 of FIG. 2A, which has an electronically scanned first antenna 76, requires a slightly different processing system than the processing system 150, and is discussed below in conjunction with FIG. 4A.

In some embodiments, the degrees of pointing accuracy are in simple angles, wherein the first degree of pointing accuracy corresponds to a pointing error of about twenty milli-radians, the second degree of pointing accuracy corresponds to a pointing error of about one milli-radian, and the third degree of pointing accuracy corresponds to a pointing error of about ten micro-radians if the second antenna is electronically scanned. However, if the second antenna were to be mechanically scanned, the third degree of pointing accuracy would correspond to a pointing error of about 100 micro-radians.

The processing system 150 can be coupled to receive at least one of an inertial navigation system (INS) signal 192 or a global positioning system (GPS) signal 194 as may be received, for example, from the INS 62 or from the GPS 64 of FIG. 2 or 3.

The processing system 150 can also be configured to provide signals 158 to and from the first antenna, (e.g., 54 or 104). The processing system 150 can also be configured to provide signals 152 to and from the second antenna 56.

The gimbal control processor 186 is configured to generate a first antenna control signal 186a in the form of a gimbal control signal 186a. The optical beam steer controller 172 is configured to generate a second antenna control signal 172a in the form of an optical antenna phase control signal 172a. It will be appreciated that the gimbal control signal 186a can move the first antenna (e.g., 54 or 104) by way of a gimbal assembly, for example, the gimbal assembly 58 of FIG. 2 or 3. It will be understood, that in moving the first antenna (e.g., 54 or 104), the gimbal assembly 58 also moves the second antenna 56, which is rigidly coupled to the first antenna (e.g., 54 or 104).

It will also be understood that because the first antenna optimizes the beam position relative to the target within the second degree of pointing accuracy, the second antenna need only scan over an angular range that is bounded by the second degree of pointing accuracy, thereby easing the field of regard requirements for the second antenna.

The processing system 150 can include a first transmitter 178, for example, an RF transmitter 178, coupled to receive a first transmit signal 174, signal A 174, for transmission via a first signal interface 184, for example, an RF signal interface 184, to a satellite or to another system via the first antenna (e.g., 54 or 104), for example, via an RF antenna. The processing system 150 can also include a second transmitter 164, for example, an optical transmitter 164, coupled to receive a second transmit signal 160, signal B 160, for transmission via a second signal interface 170, for example, an optical signal interface 170, to the same satellite or to the same other system via the second antenna 56, for example, via an optical antenna. In some embodiments, the first and second transmit signals 174, 160 carry the same signal content but at different data rates. In other embodiments the first and second transmit signals 174, 160 carry different signal content, and at different data rates. In some other embodiments, the data rate of the first and second transmit signals 174, 160 can be the same data rate. In examples further described below, it is assumed that the first and second transmit signals 174, 160 carry the same signal content but at different data rates.

The processing system 150 can include a first receiver 180, for example, an RF receiver 180, coupled to receive a first receive signal 184a via the RF signal interface 184 from the satellite or from the other system via first the first antenna (e.g., 54 or 104). The processing system 150 can also include a second receiver 166, for example, an optical receiver 166, coupled to receive a second receive signal 170a via the optical signal interface 170 from the same satellite or from the same other system via the second antenna 56. In some embodiments, the first and second received signals 184a, 170a, respectively, have the same signal content but at different data rates. In other embodiments the first and second received signals 184a, 170a carry different signal content, but at different data rates. In some other embodiments, the data rate of the signals 184a, 170a can be the same data rate. In examples further described below, it is assumed that the first and second receive signals 184a, 170a carry the same signal content but at different data rates.

The processing system 150 can also include a first tracking processor 182, for example, an RF tracking processor 182, coupled to receive a receive signal 180a from the RF receiver 180. The RF tracking processor 182 is configured to generate a first tracking signal 182a, for example, an RF tracking signal 182a, which is configured to control the gimbal control processor 186 to generate the first antenna control signal 186a in order to point a beam of the first antenna (e.g., 54 or 104) generally toward the target.

It will be appreciated that the RF tracking processor 182 can generate, at some times, the first tracking signal 182a in response to the receive signal 180a. However, the RF tracking processor 182 can also be coupled to receive at least one of the INS signal 192 or the GPS signal 194 and can generate, at some other times, the first tracking signal 182a in response to the INS signal 192 or to the GPS signal 194, or both.

The processing system 150 can also include a second tracking processor 168, for example, an optical tracking processor 168, coupled to receive a receive signal 166a from the optical receiver 166. The optical tracking processor 168 is configured to generate a second tracking signal 168a, for example, an optical tracking signal 168a, which is configured to control the optical beam steer processor 172 to generate the second antenna control signal 172a in order to point a beam of second antenna 56 generally toward the target.

It will be appreciated that the optical tracking processor 168 can generate, at some times, the second tracking signal 168a in response to the receive signal 166a. However, the optical tracking processor 168 can also be coupled to receive at least one of the INS signal 192 or the GPS signal 194 and can generate, at some other times, the second tracking signal 168a in response to the INS signal 192 or to the GPS signal 194, or both.

The processing system 150 can also include a combined tracking processor 190, which can be coupled to receive at least one of INS signal 192 or the GPS signal 194, and also to receive the first tracking signal 182a and the second tracking signal 168a. The combined tracking processor 190 can be configured to generate a combined tracking signal 190a received by the first and second control processors 186, 172, respectively. At some times, the combined tracking processor 190 is responsive to the first tracking signal 182a or the second tracking signal 168a, or both. At some times, the combined tracking signal 190a can be responsive to the INS signal 192 or to the GPS signal 194, or both.

The processing system 150 can also include a target position database 188, which can contain data representative of positions of one or more targets, for example, satellites, with which the systems 50 or 100 of FIG. 2 or 3, respectively, can communicate. The target position database 188 can be configured to provide a target position signal 188a to the RF tracking processor 182. In some embodiments, the RF tracking processor 182 can also be coupled to a manual-operated ‘joy stick’ for inputting target positions obtained from a heads-up display reticule.

Operation of the processing system 150 is described below in conjunction with FIGS. 5-5C and 6.

Referring now to FIGS. 4A, in which like elements of FIGS. 4 are shown having like reference designation, a processing system 200 can be used as the processing system 80 of FIG. 2A, wherein the first antenna 76 has beams that are electronically steered rather than mechanically steered. The processing system 200 of FIG. 4A is like the processing system 150 of FIG. 4, except the first control processor 86, i.e., the gimbal control processor 186, is replaced with an RF beam steer processor 202, which is configured to generate a second antenna control signal 202a as an RF phase control signal 202a to control a direction of a beam of the first antenna 76 of FIG. 2A, rather than the gimbal control signal 186a of FIG. 4. In addition, the first tracking signal 182a is coupled to the optical tracking processor 168 for reasons that will become apparent from the discussion below.

In essence, the first tracking signal 182a provides information to the optical tracking processor 168 indicative of an electronic pointing direction of a beam of the first antenna 76, allowing the second antenna 56 of the system 72 of FIG. 2A to electronically point its beam generally toward the target in cooperation with the first antenna 76.

It will be recognized that in the systems 50 and 100 of FIGS. 2 and 3, respectively, the beam pointing cooperation occurs mechanically, wherein the first antennas 54, 104, respectively, physically move to point respective beams toward the target, thereby physically moving the second antenna 56 to point its beam (e.g., beam perpendicular to the face of the second antenna 56, which is assumed to be co-boresighted with the boresight of the first antennas, 54, 104) generally toward the target in cooperation with the first antennas 54, 104. In contrast, it will be recognized that in the system 72 of FIG. 2A, the beam pointing cooperation occurs electronically, wherein the first antenna 74 is electronically steered to point a beam toward the target, and the second antenna 56 is electronically steered to point its beam generally toward the target in cooperation with the first antenna 74. Therefore, in all of the arrangements described herein, the first and second antennas operate cooperatively to point toward the target. It will be recognized that this positions the beam of the second antenna 56 relative to the target within an angular uncertainty bounded by the second degree of pointing accuracy of the first antennas 54, 76, 104.

FIGS. 5-5C below show a four-step process of aiming the dual-band antenna (e.g., 50, 72, or 100 of FIG. 2, 2A, or 3, respectively) toward a target. In a first step shown in FIG. 5, a beam of the first antenna (e.g., 54, 76, or 104 of FIG. 2, 2A, or 3) is first and initially pointed generally toward a target in response to the inertial navigation signal 192 (FIGS. 4, 4A), and/or the GPS signal 194 (FIGS. 4, 4A), and in response to the target position signal 188a (FIGS. 4, 4A) if there is such. In a second step shown in FIG. 5A, the beam of the first antenna (e.g., 54, 76, or 104) is then re-aimed to establish or enhance communication with the target. In a third step shown in FIG. 5B, a beam of the second antenna 56 (FIG. 2, 2A, or 3) is then aimed to the current center of the first beam and can be scanned to establish communication with the target. In a fourth and optional step shown in FIG. 5C, the beam of the first antenna (e.g., 54, 76, or 104) is then re-aimed again to point in concurrence with and align with the beam of the second antenna 56.

Referring now to FIG. 5, a target 226 can correspond, for example, to a satellite. A first antenna (e.g., 54, 76, or 104 of FIG. 2, 2A, or 3) of a dual beam antenna (e.g., 52, 74, or 102 of FIG. 2, 2A, or 3) has a beam with a beampattern represented as a circle 224. The beam 224 has a center 224a, which can correspond to a maximum response axis (MRA) of the beam 224. It will be apparent that the beam 224 does not point toward the target 226, and therefore, communication with the target 226 via the first antenna (e.g., 54, 76, or 104) is not possible.

The beam 224 of the first antenna (e.g., 54, 76, or 104) is moved by a first antenna control signal 186a (FIG. 4) or 202a (FIG. 4A) to point toward or almost toward the target 226 in response to at least one of the INS signal 192 (FIGS. 4, 4A) or the GPS signal 194 (FIGS. 4, 4A), and/or in response to the target position signal 188a (FIGS. 4, 4A), which together can operate to initially point a beam of the first antenna (e.g., 54, 76, or 104) generally toward the target but with a first pointing error 228, i.e., with the first degree of pointing accuracy described above in conjunction with FIG. 4. To this end, the first antenna control processor (e.g., 186, 202, FIGS. 4, 4A) can first be configured via the first tracking processor 182 (FIGS. 4, 4A) to initialize the pointing direction to point the beam 224 of the first antenna (e.g., 54, 76, or 104) toward the target 226 with the first degree of pointing accuracy.

As described above, it will be understood that “pointing error” and “degree of pointing accuracy” have an inverse relationship. In other words, a large pointing error results in or from a small degree of pointing accuracy (less accurate) and vice versa.

In order to achieve an enhanced alignment described below in conjunction with FIG. 5A, a region 220, referred to herein as a “coarse region,” can be generated about the beam 224, for example, by the RF tracking processor 182 of FIG. 4 or 4A. The region 220 must be large enough to encompass the target 226. The region 220 can be subdivided in a variety of different ways, for example, with a grid 222 having a plurality of crossing points, e.g., 222a, referred to herein as “coarse pointing directions.”

In operation, the first antenna (e.g., 54, 76, or 104) can scan the region 220, for example, by moving the beam 224 of the first antenna (e.g., 54, 76, or 104) among the coarse pointing directions in order to seek the target 226. To this end, the first antenna control processor (e.g., 186, 202) is configured to scan with the first antenna (e.g., 54, 76, or 104) to point the beam 224 of the first antenna (e.g., 54, 76, or 104) more precisely toward the target 226 with the second degree of pointing accuracy described above in conjunction with FIG. 4 and below in conjunction with FIG. 5A.

It will be appreciated that, in the embodiments of FIGS. 2, 3 and 4, the first antenna control processor 186 of FIG. 4 is configured to mechanically scan with the first antenna (e.g., 54 or 104) to point the beam 224 of the first antenna (e.g., 54 or 104) more precisely toward the target 226 with the second degree of pointing accuracy. In contrast, it should also be recognized that, in the embodiments of FIGS. 2A and 4A, the first antenna control processor 202 of FIG. 4A is configured to electronically scan (beam steer) with the first antenna 76 (FIG. 2A) to point the beam 224 of the first antenna 76 more precisely toward the target 226 with the second degree of pointing accuracy.

In scanning, at each one of the coarse pointing directions, the first antenna (e.g., 54 76, or 104), or more precisely, the RF receiver 180 (FIGS. 4 and 4A) and RF tracking processor 182 (FIGS. 4 and 4A) can attempt to establish communication with the target 226. In some embodiments, the communication attempt is made by way of simple handshake protocol. At one or more of the coarse pointing directions, a communication with the target 226 is established. One of the one or more coarse pointing directions is selected from among those for which communication is established.

The selection of the coarse pointing direction can be determined in a variety of ways. For example, in some embodiments, the selected coarse pointing direction is selected based upon a largest signal power received from the target 226 via the first antenna (e.g., 54, 76, or 104). In other embodiments, the selected coarse pointing direction is selected based upon a lowest bit error rate received from the target 226 via the first antenna (e.g., 54, 76, or 104). Other arrangements are also possible to select the coarse pointing direction.

Referring now to FIG. 5A, in which like elements of FIG. 5 are shown having like reference designations, the beam 224 of the first antenna (54, 76, or 104) is pointed mechanically or electronically to point generally toward the target 226. There, a second pointing error 236 corresponding to the above-described second degree of pointing accuracy is smaller than the first pointing error 228 of FIG. 5. The second degree of pointing accuracy is designed to be no greater than the first beam diameter, so the first antenna (e.g., 54, 76, or 104) has its beam 224 positioned mechanically or electronically in a direction that can communicate with the target 226.

A second antenna, for example, the second antenna 56 (FIGS. 2, 2A, 3) of a dual beam antenna (e.g., 52, 74, or 102 of FIG. 2, 2A or 3) has a beam with a beampattern represented as a circle 234. The beam 234 is much narrower in extent than the beam 224. It will be apparent that, even though the beam 224 from the first antenna (e.g., 54, 76, or 104) points toward the target 226 with the second pointing error 236, the beam 234 from the second antenna 56 does not necessarily overlap the target 226, and therefore, communication with the target via the second antenna 56 is not yet assured.

Returning briefly to FIGS. 2 and 3, which both have the gimbal steering 58, it will be appreciated that a center 234a of the beam 234 of the second antenna is generally positioned near the center 224a of the beam 224, since the first antenna (e.g., 54 or 104) is mechanically pointed generally toward the target to achieve the pointing error 236.

However, with regard to the alternate embodiment 72 of FIG. 2A, in which the first antenna 74 is electronically steered instead of mechanically steered, and associated processing system 200 of FIG. 4A, it will be appreciated that the pointing error 236 of the first beam 224 can also be achieved by electronically beam steering with the first antenna 76 (FIG. 2A) by way of the RF beam steer processor 202 of FIG. 4A. In this case, in order to achieve the alignment of FIG. 5A, the beam 234 of the second antenna 56 of FIG. 2A can be positioned to generally align with the beam 224 by way of the RF tracking signal 182a of FIG. 4A received by the optical tracking processor 168. Note that in FIG. 4A, the optical tracking processor 168 is coupled to receive the RF tracking signal 182a, and thus, has knowledge of in what direction the first antenna 76 (FIG. 2A) is steered.

Returning now to FIG. 5A, the center 224a of the beam 224 of the first antenna (e.g., 54, 76, or 104) is moved as shown relative to the target 226. As described above, once moved, the pointing direction of the beam 224 of the first antenna (e.g., 54, 76, or 104) achieves the pointing error 236, i.e., the second degree of pointing accuracy.

The center 234a of the beam 234 of the second antenna 56 is not necessarily perfectly aligned with the center 224a of the beam 224 of the first antenna (e.g., 54, 76, or 104). A differential error 240 is shown.

In order to achieve an enhanced alignment described below in conjunction with FIG. 5B, a region 230, referred to herein as a “fine region,” can be generated about the beam 234, for example, by the optical tracking processor 168 of FIGS. 4 and 4A. The region 230 must be large enough to encompass the target 226. The region 230 can be subdivided in a variety of different ways, for example, with a grid 232 having a plurality of crossing points, e.g., 232a, referred to herein as “fine pointing directions.”

In operation, the second antenna 56 can scan the region 230, for example, by moving the beam 234 of the second antenna 56 among the fine pointing directions in order to seek the target 226. To this end, the second antenna control processor 172 of FIGS. 4 and 4A is configured to electronically scan (beam steer) with the second antenna 56 to point the beam 234 of the second antenna 56 more precisely toward the target 226 with the third degree of pointing accuracy described above in conjunction with FIG. 4 and below in conjunction with FIG. 5B.

In scanning, at each one of the fine pointing directions, the second antenna 56, or more precisely, the optical receiver 166 (FIGS. 4 and 4A) and optical tracking processor 168 (FIGS. 4 and 4A) can attempt to establish communication with the target 226. As with the first antenna communication described above, in some embodiments, the communication attempt is made by way of simple handshake protocol. At one or more of the fine pointing directions, a communication with the target 226 is established. One of the one or more fine pointing directions is selected from among those for which communication is established.

In some embodiments, in order to assist with acquisition of the target 226, the beam 234 of the second antenna 56 can be deliberately and temporarily ‘spoiled’; i.e., its beam size can be increased by programming a phase profile of an electronic lens onto the array or by temporarily inserting a bulk lens into the beam, either approach having the effect of making the size of the second beam 234 match or exceed the angular extent of the expected second pointing error 236, thereby ensuring that the spoiled second beam does overlap the target. When the second beam is spoiled, its energy is spread over a larger area, and there may not be sufficient signal strength to enable communication with the target 226, despite the beam overlapping the target 226. In this case, the communication data rate can be reduced until the signal strength is sufficient for communication. Once a communication link is established, the beam 234 can be centered on the target 236 (FIG. 5B) within the angular uncertainty bounded by a third pointing error described below, which is designed to be smaller than the size of the second beam 234, the second beam 234 can be de-spoiled back to its near diffraction limited size, and the data rate can be reset to the maximum rate compatible with the aligned and focused signal strength.

Like the selection of the coarse pointing direction described above, the selection of the fine pointing direction can be determined in a variety of ways. For example, in some embodiments, the selected fine pointing direction is selected based upon a largest signal power received from the target 226 via the second antenna 56. In other embodiments, the selected fine pointing direction is selected based upon a lowest bit error rate received from the target 226 via the second antenna 56. Other arrangements are also possible.

Referring now to FIG. 5B, in which like elements of FIGS. 5-5A are shown having like reference designations, the beam 234 of the second antenna 56 is steered electronically to point generally toward the target 226. There, a third pointing error (not shown for clarity, but between the center 234a of the beam 234 and the target 226), corresponding to the above-described third degree of pointing accuracy, is smaller than the second pointing error 236 of FIG. 5A. The second antenna 56 has the beam 234 positioned electronically in a direction that can communicate with the target 226.

It will be apparent that, even though the beam 234 from the second antenna 56 points toward the target 226 with the third pointing error (not shown), the beam 224 from the first antenna (e.g., 54, 76, or 104), while still pointing generally toward the target 226, is not well aligned with the target 226, and therefore, communication with the target 226 via the first antenna (e.g., 54, 76, or 104) is not as good as that which may be achieved with better alignment.

Referring now to FIG. 5C, in which like elements of FIGS. 5-5B are shown having like reference designations, optionally, the beam 224 of the first antenna (e.g., 54, 76, or 104) can be brought into general alignment with the beam 234 of the second antenna 56. A residual differential pointing error difference 244 may be present after final alignment. For reasons described below in conjunction with block 266 of FIG. 6, the last alignment of FIG. 5C may not be realizable, since granularity of movement of the first beam 224 may be too great to allow it to be re-aligned.

Referring now to FIG. 6, a process 250 begins at block 252, where the first antenna (e.g., 54, 76, or 104 of FIGS. 2, 2A, and 3, respectively) of the dual-band antenna (e.g., 52, 74, or 102 of FIGS. 2, 2A, and 3, respectively) is initially aligned using at least one of the INS signal 192 of FIGS. 4 and 4A, the GPS signal 194 of FIGS. 4 and 4A, or the target position signal 188a of FIGS. 4 and 4A. The initial alignment can achieve the alignment described above in conjunction with FIG. 5.

At block 254, the first antenna scans, either mechanically, as do the systems 50 and 100 of FIGS. 2 and 3, or electronically, as does the system 72 of FIG. 2A, in order to acquire, i.e., establish communication with, a target. Once the target is acquired with the first antenna (e.g., 54, 76, or 104), the dual-band antenna (e.g., 52, 74, or 102) achieves the alignment described above in conjunction with FIG. 5A.

In some embodiments, a best one of a plurality of pointing directions of the beam of the first antenna (52, 74, 102) can be selected, each of which achieves the acquisition of the target. The selection can be based upon a variety of parameters, including but not limited to a bit error rate (BER) and a signal strength.

At block 256, if communication (e.g., a best communication) with the target is achieved with the first antenna (e.g., 54, 76, or 104), then the process continues to block 258.

At block 258, the first antenna (e.g., 54, 76, or 104) can be used for communication with the target and for tracking the target with the beam of the first antenna (e.g., 54, 76, or 104), for example using the RF tracking processor 182 of FIGS. 4 and 4A.

At block 260, the second antenna 56 (FIGS. 2, 2A, 3) electronically scans in order to acquire the target. As described above in conjunction with FIG. 5A, beam spoiling may be used to assist target acquisition. Once the target is acquired with the second antenna 56, the dual-band antenna (e.g., 50, 72, or 100) achieves the alignment described above in conjunction with FIG. 5B.

In some embodiments, a best one of a plurality of pointing directions of the beam of the second antenna 56 can be selected, each of which achieves the acquisition of the target. The selection can be based upon a variety of parameters, including but not limited to a bit error rate (BER) and a signal strength.

At block 262, if communication (e.g., a best communication) with the target is achieved with the second antenna 56, then the process continues to block 264.

At block 264, the second antenna 56 can be used for communication with the target in place of or in addition to the first antenna (e.g., 54, 76, or 104), and also to track the target to a higher degree of pointing accuracy, for example, with the optical tracking processor 168 of FIGS. 4 and 4A.

At block 266, optionally, the pointing direction of the beam of the first antenna (e.g., 54, 76, or 104) can be adjusted to more accurately point toward the target by knowing the pointing direction of the beam of the second antenna 56. Once the adjustment is made, the dual-band antenna (e.g., 52, 74, or 102) achieves the alignment described above in conjunction with FIG. 5C.

However, it will be recognized that the pointing direction of the beam of the first antenna (e.g., 54, 76, or 104) may only be positioned with a certain granularity, which is typically no smaller than 1/100^{th} of a beam size of the beam of the first antenna (e.g., 54, 76, or 104). With an exemplary beam size of the first antenna (e.g., 54, 76, or 104) of one degree, the pointing direction of the beam of the first antenna can be moved only in about 1/100^{th} degree increments, or about 170 microradians. In some arrangements, that minimum step size can be larger than the beam size of the second antenna 56, which, for at least the case of an optical phased array antenna, can be in a range of about ten to about one hundred microradians. Therefore, the step represented by block 266 may not be realizable.

At block 268, communications using the second antenna 56 are monitored, and at block 270, if communications with the target using the second antenna 56 are lost, then the process continues to block 272.

At block 272, the communications with the target and tracking of the target can switch from the second antenna 56 to the first antenna (e.g., 54, 76, or 104).

At block 274, communications using the first antenna (e.g., 54, 76, or 104) are monitored, and at block 274, if communications with the target using the first antenna (e.g., 54, 76, or 104) are lost, then the process returns to block 252, or optionally, to block 254.

At block 274, if communications with the target using the first antenna (e.g., 54, 76, or 104) are not lost, then the process returns to block 260, where scanning is again performed using the second antenna 56, attempting to reacquire the target. However, it should be recognized that, in the case where the second antenna 56 is an optical antenna, communications can be lost for substantial periods of time, for example, in the case of bad weather.

At block 270, if communications with the target using the second antenna 56 are not lost, then the process returns to block 268 to continue to monitor the communications with the second antenna 56.

If at block 262, communications with the target using the second antenna 56 are not achieved, then to process returns to block 260, where scanning is repeated using the second antenna 56.

If at block 256, communications with the target using the first antenna (e.g., 54, 76, or 104) are not achieved, then to process returns to block 254, where scanning is repeated using the first antenna (e.g., 54, 76, or 104).

As described above, in some embodiments, the first antenna (e.g., 54, 76, or 104) can be an RF antenna operating at an RF band and the second antenna 56 can be an optical antenna operating in an optical band, which has a higher frequency than the RF band. However, the first and second antennas can be any two antennas rigidly attached to each other, wherein the second antenna operates at a higher frequency than the first antenna.

In one embodiment described above in conjunction with FIG. 2, the first antenna 54 is a planar RF antenna steered with a gimbal assembly 58 and the second antenna 56 is a free-space optical (FSO) telescope, both configured to communicate with a given satellite. In another embodiment described above in conjunction with FIG. 2A, the first antenna 74 is a planar RF antenna that is electronically steered and the second antenna 56 is the free-space optical (FSO) telescope, both configured to communicate with a given satellite. In another embodiment described above in conjunction with FIG. 3, the first antenna 104 is an RF dish antenna steered with the gimbal assembly 58 and the second antenna 56 is the free-space optical (FSO) telescope, both configured to communicate with a given satellite.

The RF antenna (e.g., 54, 76, or 104) can perform initial acquisition and can be used to search for the target. The FSO antenna 56 can then be used to further search for the target. Optionally, though not realizable in all embodiments, FSO tracking can be used to point the RF antenna (e.g., 54, 76, or 104) when both the RF and FSO links are operating. If bad weather or some other condition or characteristic interferes with the FSO link, a reliable, but lower bandwidth RF link can be maintained by using the first antenna (e.g., 54, 76, or 104). During favorable weather, the FSO link can carry high bandwidth traffic.

This system and technique finds use in any free space communications link that requires very high bandwidth (e.g. over one gigabit per sec.) and that also has an RF link acting as a low bandwidth but reliable back up.

In some embodiments, the dual-band antenna (e.g., 52, 74, or 102) is attached to a moving platform 70 (FIGS. 2, 2A, and 3), for example, an aircraft. In this case, it will be appreciated that the INS 62 of FIGS. 2, 2A, and 3 and the corresponding INS signal 192 of FIGS. 4 and 4A can be used to continually aim the beams of the first antenna (e.g., 54, 76, or 104) and the second antenna 56 toward the target, once the target is acquired with both beams.

In other embodiments, the platform 70 can be a mobile ground platform or a satellite. In other embodiments, the dual-band antenna (e.g., 52, 74, or 102) is affixed to a stationary platform 70. All of these platforms, moving or stationary, require acquisition, pointing, and tracking solutions.

The communication link (e.g., FSO link) of the second antenna 56 can have a very narrow beamwidth, and therefore, can be more difficult to point to the target than the communication link (e.g., RF link) of the first antenna (e.g., 54, 76, or 104), which can have a wider beamwidth. Thus, it is desirable to utilize the first antenna (e.g., 54, 76, or 104), which has the wider beamwidth, to initially assist with identifying a pointing direction to the target.

The dual-band antenna pointing, acquisition, and tracking systems described herein allow two antennas to cooperate and act as one terminal even if at different bandwidths, which greatly reduces the complication of tracking, since only one tracking problem is solved for the two antennas rather than two separate tracking problems.

In all embodiments described above, the second antenna 56 is rigidly coupled to the first antenna (e.g., 54, 76, or 104), and therefore, the relative geometry between the two antennas is known. Both antennas point to a common target, e.g., the same satellite or aircraft. Therefore, it is possible to exploit pointing and tracking knowledge from one antenna and use for the other.

In one exemplary embodiment, a hybrid terminal has both radio frequency (RF) and free-space optic (FSO) apertures on the terminal. The target can be a satellite or aerial vehicle with both RF and optical communications channels.

In some embodiments, the first antenna (e.g., 52, 76, 104) is an RF antenna and the second antenna 56 is a phased array optical antenna. In some embodiments, the first antenna (e.g., 52, 104) is a mechanically steered RF antenna and the second antenna 56 is a phased array optical antenna. In some embodiments, the first antenna (e.g., 76) is a phased array RF antenna and the second antenna 56 is a phased array optical antenna.

In another exemplary embodiment, both the first and second antennas are RF antennas operable at the same frequency or similar frequencies, but with different apertures sizes, resulting in two different beamwidths.

In yet another exemplary embodiment, both the first and second antennas are RF antennas operable at different frequencies, but with the same aperture size, also resulting in two different beamwidths. The two RF antennas can both be phased array antennas.

In still exemplary embodiment, one phased array antenna provides both the first and second antennas, wherein a narrow-beam (e.g. a second antenna beam) is achieved using the whole aperture and a wide-beam (e.g., a first antenna beam) is achieved using a portion of the aperture.

Acquisition proceeds by utilizing the first antenna (e.g., 54, 76, or 104) to perform a spatial search. The spatial search is accomplished by scanning the sky by steering the beam of the first antenna (e.g., 54, 76, or 104). Once the first antenna (e.g., 54, 76, or 104) acquired the target, for a moving platform or for a moving target, the first antenna (e.g., 54, 76, or 104) commences to track using a monopulse or scan feedback. When the first antenna (e.g., 54, 76, or 104) is tracking, the system performs acquisition using the second antenna 56. Once the second antenna 56 acquires its signal, the second antenna 56 can track the target and relieve the first antenna (e.g., 54, 76, or 104) and associated processors of tracking processing. But it need not do so; the two antennas can operate independently.

All references cited herein are hereby incorporated herein by reference in their entirety.

Having described preferred embodiments, which serve to illustrate various concepts, structures and techniques, which are the subject of this patent, it will now become apparent to those of ordinary skill in the art that other embodiments incorporating these concepts, structures and techniques may be used. Accordingly, it is submitted that scope of the patent should not be limited to the described embodiments but rather should be limited only by the spirit and scope of the following claims.

What is claimed is:

1. A method of tracking a target, comprising:
initializing a pointing direction to point a beam of a first antenna toward the target with a first degree of pointing accuracy, wherein the first antenna is within a dual-band antenna, wherein the dual-band antenna comprises:
the first antenna; and
a second antenna rigidly coupled to the first antenna; wherein the first antenna is configured to communicate within a first frequency band and the second antenna is configured to communicate within a second frequency band higher in frequency than the first frequency band, wherein the second antenna has an aperture width substantially smaller than an aperture width of the first antenna;
scanning with the first antenna to point a beam of the first antenna to the target with a second degree of pointing accuracy; and
electronically scanning with the second antenna in directions related to the pointing direction of the beam of the first antenna to point a beam of the second antenna to the target with a third degree of pointing accuracy, wherein the third degree of pointing accuracy is more accurate than the second degree of pointing accuracy, and wherein the second degree of pointing accuracy is more accurate than the first degree of pointing accuracy.

2. The method of claim 1, wherein the first frequency band is in the radio frequency range and the second frequency band is in the light frequency range.

3. The method of claim 1, wherein the first antenna comprises an RF antenna and the second antenna comprises an optical phased array.

4. The method of claim 3, wherein the initializing the pointing direction comprises:
receiving at least one of an inertial navigation signal or a global positioning signal, wherein the inertial navigation signal is indicative of a position of a platform to which the dual-band antenna is coupled, and wherein the global positioning signal is indicative of earth-referenced coordinates of a location of the dual-band antenna;
receiving a target position signal indicative of a position of the target; and
initializing the pointing direction in accordance with the target position signal and with the at least one of the inertial navigation signal or the global positioning signal.

5. The method of claim 4, wherein the initializing the pointing direction comprises:
generating a first antenna control signal to have a first signal value resulting in pointing the beam of the first antenna to an initial pointing direction.

6. The method of claim 5, wherein the scanning with the first antenna comprises:
selecting a coarse region about the initial pointing direction;
generating the first antenna control signal to have a plurality of signal values resulting in pointing the beam of the first antenna to a respective plurality of coarse pointing directions within the coarse region; and
selecting one of the plurality of control signal values to establish a respective selected one of the plurality of coarse pointing directions.

7. The method of claim 6, wherein the selecting the one of the plurality of control signal values comprises:
attempting to establish a radio frequency communication with the target at each one of the plurality of coarse pointing directions; and
identifying the selected one of the plurality of coarse pointing directions that achieves the radio frequency communication.

8. The method of claim 6, wherein the scanning with the second antenna comprises:
selecting a fine region about the selected one of the plurality of coarse pointing directions;
altering a phase control signal to the optical phased array to have a plurality of phase control values resulting in pointing a direction of a beam of the optical phased array to a respective plurality of fine pointing directions within the fine region; and
selecting one of the plurality of phase control values to establish a respective selected one of the plurality of fine pointing directions.

9. The method of claim 8, wherein the selecting the one of the plurality of phase control values comprises:
attempting to establish an optical frequency communication with the target at each one of the plurality of fine pointing directions; and
identifying the selected one of the plurality of fine pointing directions that achieves the optical frequency communication.

10. The method of claim 1, wherein the first frequency band is in the radio frequency range, the second frequency band is in the radio frequency range and higher in frequency than the first frequency band, the first antenna comprises a first RF antenna, and the second antenna comprises a second RF antenna.

11. A system for tracking a target, comprising:
a dual-band antenna, comprising:
a first antenna; and
a second antenna rigidly coupled to the first antenna; wherein the first antenna is configured to communicate within a first frequency band and the second antenna is configured to communicate within a second frequency band higher in frequency than the first frequency band, wherein the second antenna has an aperture width substantially smaller than an aperture width of the first antenna; and
a processing system comprising:
a first antenna control processor configured to initialize a pointing direction to point a beam of the first antenna toward the target with a first degree of pointing accuracy, and configured to scan with the first antenna to point the beam of the first antenna more precisely toward the target with a second degree of pointing accuracy; and
a second antenna control processor configured to electronically scan with the second antenna in directions related to the pointing direction of the beam of the first antenna to point a beam of the second antenna to the target with a third degree of pointing accuracy, wherein the third degree of pointing accuracy is more accurate than the second degree of pointing accuracy, and wherein the second degree of pointing accuracy is more accurate than the first degree of pointing accuracy.

12. The system of claim 11, wherein the first frequency band is in the radio frequency range and the second frequency band is in the light frequency range.

13. The system of claim 11, wherein the first antenna comprises an RF antenna and the second antenna comprises an optical phased array.

14. The system of claim 13, wherein the first antenna control processor is coupled to receive at least one of an inertial navigation signal or a global positioning signal, wherein the inertial navigation signal is indicative of a position of a platform to which the dual-band antenna is coupled, and wherein the global positioning signal is indicative of earth-referenced coordinates of a location of the dual-band antenna, wherein first antenna control processor is further coupled to receive a target position signal indicative of a position of the target, and wherein the first antenna control processor is further configured to initialize the pointing direction in accordance with the target position signal and in accordance with the at least one of the inertial navigation signal or the global positioning signal.

15. The system of claim 14, wherein the first antenna control processor is configured to generate the first antenna control signal to have a first value resulting in pointing the beam of the first antenna to an initial pointing direction.

16. The system of claim 15, wherein the system further comprises:
a first tracking processor coupled to receive a signal representative of a signal received by the first antenna and configured to identify a coarse region about the initial pointing direction, wherein the first antenna control processor is coupled to receive a control signal from the first tracking processor, wherein the first antenna control processor is configured to generate the first antenna control signal to have a plurality of values resulting in pointing the beam of the first antenna to a respective plurality of coarse pointing directions within the coarse region, wherein the first antenna control processor is configured to select one of the plurality of control values to establish a respective selected one of the plurality of coarse pointing directions.

17. The system of claim 16, wherein the first tracking processor is configured to attempt to establish a radio frequency communication with the target at each one of the plurality of coarse pointing directions and configured to identify the selected one of the plurality of coarse pointing directions that achieves the radio frequency communication.

18. The system of claim 16, further comprising:
a second tracking processor configured to identify a fine region about the selected one of the plurality of coarse pointing directions; and
an optical beam steer controller configured to alter a phase control signal to the optical phased array to have a plurality of phase control values resulting in pointing a direction of a beam of the optical phased array to a respective plurality of fine pointing directions within the fine region, wherein the second tracking processor is configured to select one of the plurality of phase control values to establish a respective selected one of the plurality of fine pointing directions.

19. The system of claim 18, wherein the second tracking processor is configured to attempt to establish an optical frequency communication with the target at each one of the plurality of fine pointing directions and configured to identify the selected one of the plurality of fine pointing directions that achieves the optical frequency communication.

20. The system of claim 11, wherein the first frequency band is in the radio frequency range, the second frequency band is in the radio frequency range and higher in frequency than the first frequency band, the first antenna comprises a first RF antenna, and the second antenna comprises a second RF antenna.

21. The system of claim 11, further comprising:
a gimbal assembly coupled to rotationally move the dual-band antenna about at least one axis in response to a gimbal control signal, wherein the first antenna control processor comprises a gimbal control processor configured to generate the gimbal control signal to mechanically initialize the pointing direction of the beam of the first antenna to point toward the target with the first degree of pointing accuracy;

21. The system of claim 21, wherein the gimbal control processor is further configured to generate the gimbal control signal to mechanically scan with the first antenna to point the dual-band antenna to the target with the second degree of pointing accuracy.
